(19) United States
(12) Patent Application Publication
(10) Pub. No.: US 2021/0288439 A1
(43) Pub. Date: Sep. 16, 2021

(54) CONNECTOR

(71) Applicant: Sumitomo Wiring Systems, Ltd., Yokkaichi, Mie (JP)

(72) Inventor: Masato Kamemura, Yokkaichi, Mie (JP)

(21) Appl. No.: 16/618,832

(22) PCT Filed: Jun. 5, 2018
(86) PCT No.: PCT/JP2018/021481

§ 371 Date: Dec. 3, 2019

(30) Foreign Application Priority Data
Jun. 23, 2017 (JP) 2017-123194

(51) Int. Cl. H01R 13/627; H01R 13/639; H01R 13/641; H01R 13/436

(52) U.S. Cl. CPC H01R 13/6272; H01R 13/4364; H01R 13/641; H01R 13/639

(57) ABSTRACT

A connector 1 includes a first housing 10 having a first lock portion 17, a second housing 50 having a second lock portion 52 to be locked to the first lock portion 17 and connectable to the first housing 10, and a CPA latch 30 relatively movable with respect to the first lock portion 17. The CPA latch 30 is movable to a release position where a locked state of the first lock portion 17 and the second lock portion 52 is releasable, a connection assurance position where a connected state of the first housing 10 and the second housing 50 is assured by the CPA latch 30 moving over a locking portion 70 of the first lock portion 17 and the second lock portion 2 from the release position, and an operation stop position where a separating operation is stopped by the CPA latch 30 being locked to the second lock portion 52 while the first housing 10 and the second housing 50 are being separated.

### BACKGROUND

### Field of the Invention

A technique disclosed by this specification relates to a connector.

### Related Art

Japanese Unexamined Patent Application Publication No. 2012-511805 discloses a connector assembly composed of a plug outer housing including a flexible latch, a floating latch slidably connected to the plug outer housing, and a header outer housing to be connected to the plug outer housing. The floating latch has a substantially rectangular shape and a substantially rectangular cutout is formed inside. A locking tab projects down on a rear part of the floating latch.

A locking claw projects up on the floating latch. The locking tab of the floating latch contacts the locking claw of the flexible latch so that the floating latch is locked to the flexible latch. Further, a projection projects up on the header outer housing. This projection contacts an inner wall of a front part of the floating latch so that the header outer housing is locked by the floating latch.

To release the connection of the header outer housing and the plug outer housing, the floating latch and the flexible latch are first unlocked. Subsequently, the floating latch and the header outer housing are unlocked. In this way, the connection of the header outer housing and the plug outer housing is released by two actions.

However, in the case of adding a mechanism for assuring a connection position to the above configuration, a CPA (connector position assurance lock) needs to be provided separately on the plug outer housing. In the case of providing two locking functions by the CPA and the latch in this way, two components, i.e. the CPA and the latch need to be mounted on the plug outer housing. Thus, the problem has been that the number of components of the plug outer housing increases.

### SUMMARY

This specification relates to a connector with first and second housings that are connectable to one another. The first housing has a first lock, and the second housing has a second lock that is locked to the first lock when the first and second housings are connected. A CPA latch is movable with respect to the first lock to: a release position where a locked state of the first and second locks is releasable; a connection assurance position where a connected state of the first and second housings is assured by the CPA latch moving over a locking portion of the first and second locks; and an operation stop position where a separating operation is stopped by the CPA latch being locked to the second lock while the first and second housings are being separated.

The CPA latch moves over the locking portion of the first and second locks and moves from the release position to the connection assurance position to assure the connection of the first and second housings. Further, if the first and second housings are separated after a movement of the CPA latch to the release position, the CPA latch is locked to the second lock to stop the separating operation and reaches the operation stop position. As just described, two functions, i.e. a connection assuring function and a two-action separating function can be realized by one CPA latch and the number of components can be reduced as compared to the case where the respective functions are realized by different components as before.

The CPA latch may include a latch portion and a latch pressing portion. The separating operation may be stopped by the contact of the latch portion and the second lock at the operation stop position. Additionally, the latch portion may be displaced in a direction opposite to the latch pressing portion, and the latch portion and the second lock portion may be brought out of contact if the latch pressing portion is displaced, thereby making the first housing and the second housing separable. By adopting this configuration, the connection of the first and second housings is released by bringing the second lock and the latch portion out of contact at the operation stop position. The latch portion also can be displaced in a seesaw manner to release the connection by pressing and displacing the latch pressing portion of the CPA latch. Thus, a connection releasing operation at the operation stop position can be simplified, for example, as compared to the case where the latch portion is lifted and displaced directly upward.

The first housing may include a projection. Displacement of the latch pressing portion may be impeded by the contact of the CPA latch and the projection at the release position. The CPA latch may not be in contact with the projection, and the latch pressing portion may be displaceable at the operation stop position.

If the latch pressing portion was displaceable at the release position, then the first and second housings could be separated by one action without proceeding via the operation stop position if the separating operation of the first and second housings is performed with the first pressing portion and the latch pressing portion simultaneously pressed at the release position. However, a displacement of the latch pressing portion of the CPA latch at the release position is impeded in the above configuration. Thus, an improper separating operation of separating the first and second housings without proceeding via the operation stop position can be prevented.

The CPA latch may include a displacement restricting portion configured to maintain the locked state of the first and second locks by suppressing a displacement of the first lock at the connection assurance position. If the first lock was displaceable at the connection assurance position, then the first and second housings could be separated at the connection assurance position. However, if the above configuration is adopted, the displacement restricting portion of the CPA latch suppresses a displacement of the first lock and prevents the separation of the first and second housings at the connection assurance position.

According to the connector disclosed in this specification, two functions, i.e. a connection assuring function and a two-action separating function can be realized by one CPA latch.

### BRIEF DESCRIPTION OF THE DRAWING

FIG. 1 is a perspective view of a CPA latch viewed obliquely from behind.

FIG. 2 is a perspective view of the CPA latch viewed obliquely from front.

FIG. 3 is a perspective view of a first housing before the assembly of the CPA latch viewed obliquely from behind.

FIG. 4 is a perspective view of the first housing before the assembly of the CPA latch viewed obliquely from front.

FIG. 5 is a perspective view of the first housing after the assembly of the CPA latch viewed obliquely from behind.

FIG. 6 is a perspective view of the first housing after the assembly of the CPA latch viewed obliquely from front.

FIG. 7 is a front view showing the first housing and a second housing from a connected state to a separating operation completed state.

FIG. 8 is a section along A-A at a connection assurance position of FIG. 7.

FIG. 9 is a section along B-B at the connection assurance position of FIG. 7.

FIG. 10 is a section along A-A at a release position of FIG. 7.

FIG. 11 is a section along B-B at the release position of FIG. 7.

FIG. 12 is a section along A-A during a movement from the release position of FIG. 7 to an operation stop position.

FIG. 13 is a section along A-A during the movement from the release position of FIG. 7 to the operation stop position.

FIG. 14 is a section along A-A of FIG. 7 at the operation stop position of FIG. 7.

FIG. 15 is a section along B-B of FIG. 7 at the operation stop position of FIG. 7.

FIG. 16 is a section along A-A during a separating operation from the operation stop position of FIG. 7.

FIG. 17 is a section along B-B during the separating operation from the operation stop position of FIG. 7.

FIG. 18 is a section along A-A during the separating operation from the operation stop position of FIG. 7.

FIG. 19 is a section along A-A after the completion of the separating operation of FIG. 7.

### DETAILED DESCRIPTION

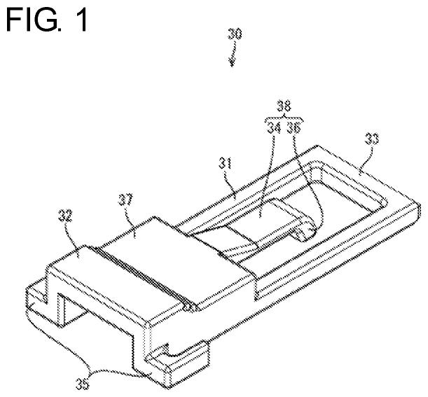

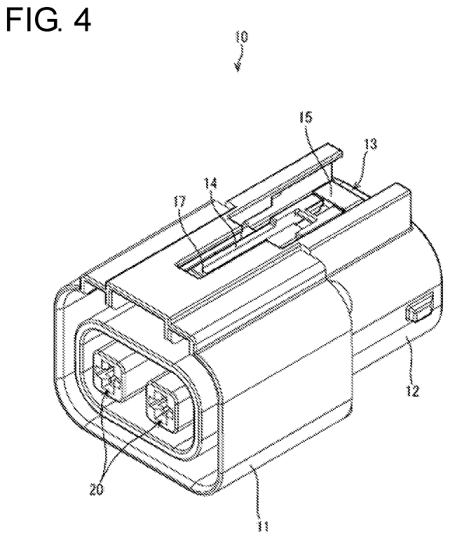

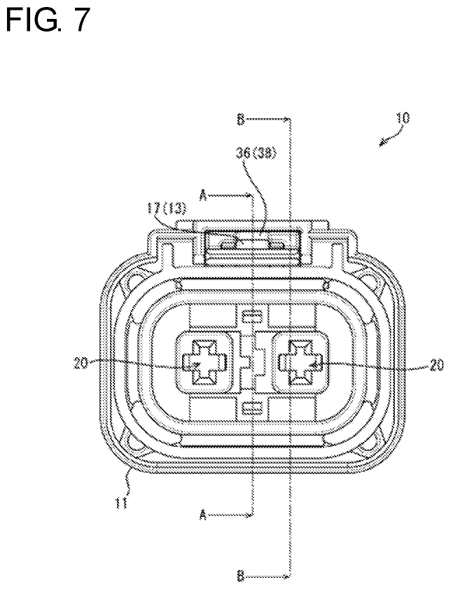

An embodiment is described with reference to FIGS. 1 to 19.

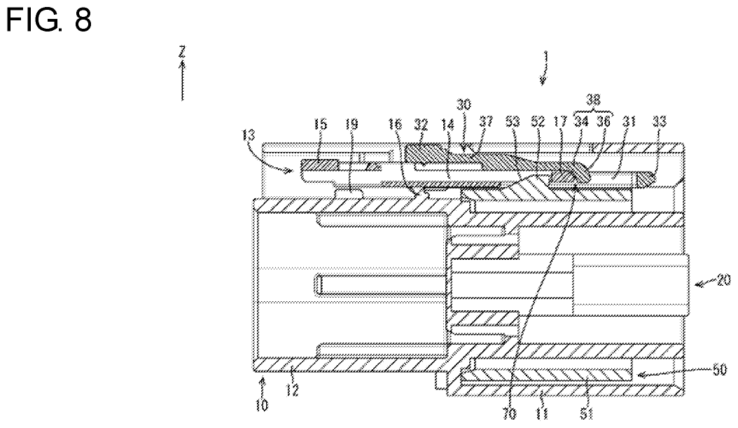

A connector 1 in this embodiment includes a first housing 10, a CPA latch 30 and a second housing 50 to be connected to the first housing 10 as shown in FIG. 8. In the following description, connection sides of the first and second housings 10, 50 are referred to as front ends, and a Z direction in FIG. 8 is referred to as an upward direction.

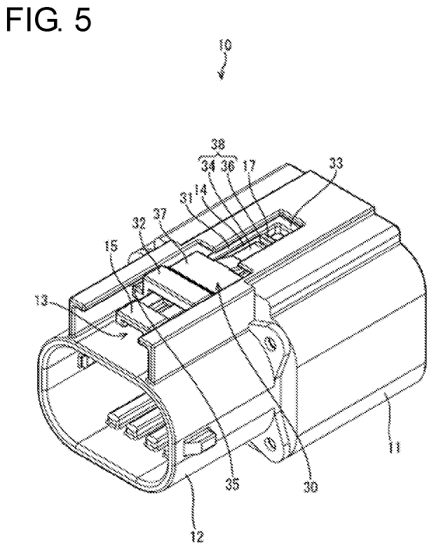

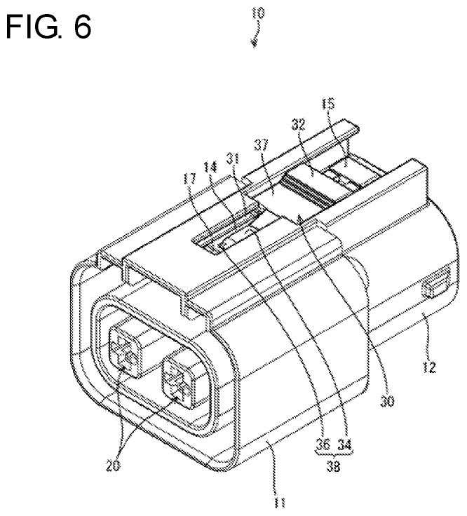

As shown in FIGS. 5 and 6, the first housing 10 is a female housing and includes a first front opening 11 open forward, a first rear opening 12 open rearward and a lock arm 13. The first housing 10 is provided with two first cavities 20 and, although not shown, female first terminals are inserted into the respective cavities 20.

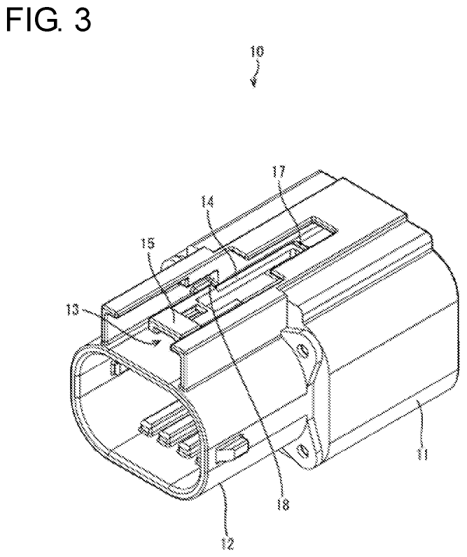

As shown in FIGS. 3, 4 and 8, the lock arm 13 is long in a front-rear direction and includes a rectangular first frame 14, a first pressing portion 15, a base end 16 and a first lock 17. Although hatching for the lock arm 13 shown in FIGS. 8 to 19 is different from that for the first housing 10, the lock arm 13 and the first housing 10 are integrated and are hatched differently merely to be seen easily.

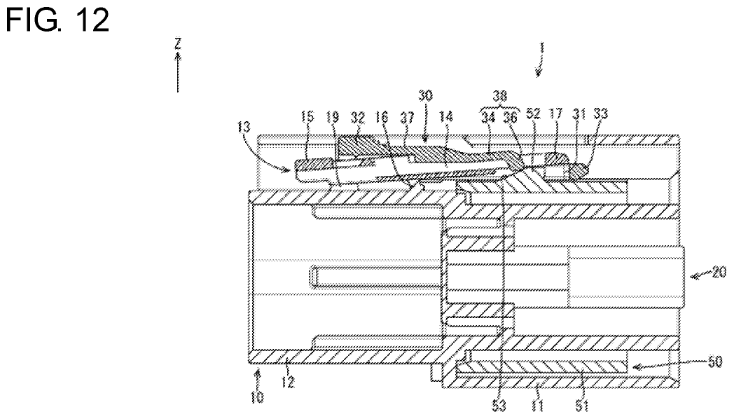

The base end 16 projects downward from the lower surface of the first frame 14, and is connected to the upper surface of the first rear opening 12. The first pressing portion 15 has a rectangular shape and is provided on a rear part of the first frame 14. The first lock 17 is provided on a front end part of the first frame 14. As shown in FIG. 12, the lock arm 13 is resiliently displaceable in a seesaw manner with the base end 16 as a fulcrum. If the first pressing portion 15 is displaced downward, the first lock portion 17 is displaced upward.

As shown in FIG. 3, restricting walls 18 for restricting a forward movement of the CPA latch 30 (to be described later) are provided between the upper surface of the first front opening 11 and the upper surface of the first rear opening 12.

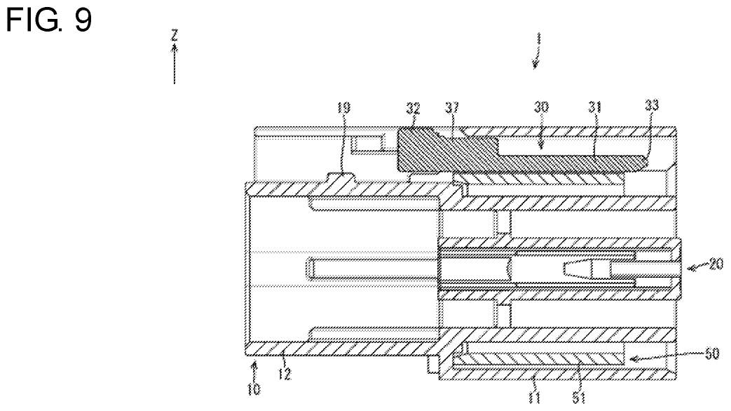

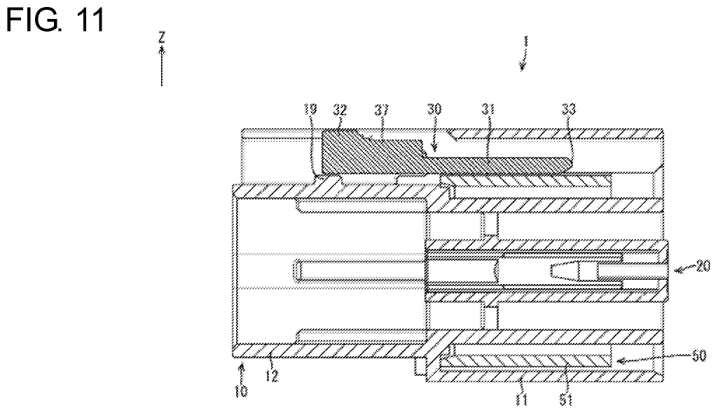

As shown in FIGS. 8 and 9, a projection 19 projects upward near a center of the upper surface of the first rear opening portion 12. As shown in FIG. 11, the projection 19 is provided to restrict a downward displacement of the CPA latch 30 by coming into contact with the CPA latch 30.

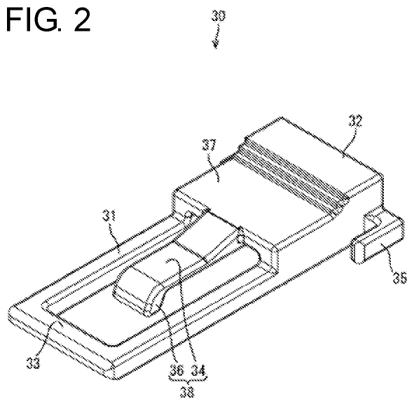

As shown in FIGS. 1 and 2, the CPA latch 30 is long in the front-rear direction and includes a rectangular CPA latch body 37, a U-shaped latch frame 31, a latch pressing portion 32, a displacement restricting portion 34 and a CPA arm 38.

As shown in FIGS. 1 and 2, the latch pressing portion 32 has a rectangular shape and projects upward from a rear part of the CPA latch body 37. Further, forward movement restricting portions 35 project from side surfaces of a rear part of the latch frame 31. The forward movement restricting portions 35 project laterally from lower side surfaces of the latch pressing portion 31 and further project forward.

The latch frame 31 projects forward from a front end part of the CPA latch body 37. A front frame of the latch frame 31 serves as a latch portion 33. The lower surface of the latch portion 33 is tapered toward a front side.

The CPA arm 38 is a cantilever and is composed of the displacement restricting portion 34 and a CPA portion 36. The displacement restricting portion 34 projects forward from the front of the CPA latch body 37, and the CPA portion 36 projects downward from a front part of the displacement restricting portion 34. The displacement restricting portion 34 is flexible in a vertical direction so that the CPA portion 36 is displaceable in the vertical direction.

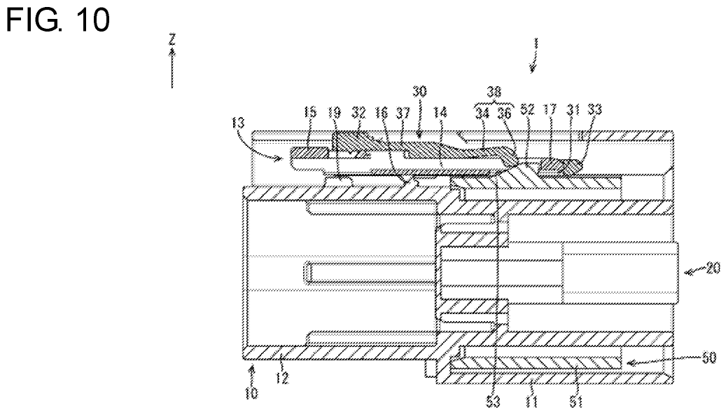

As shown in FIGS. 5 and 6, the CPA latch 30 is assembled above the lock arm 13 of the first housing 10. As shown in FIGS. 8 and 10, the CPA latch 30 is movable in the front-rear direction by sliding on the lock arm 13. If the CPA latch 30 is moved forward by a given distance, the forward movement restricting portions 35 of the CPA latch 30 contact the restricting walls 18 of the first housing 10 to restrict a forward movement of the CPA latch 30 beyond the given distance.

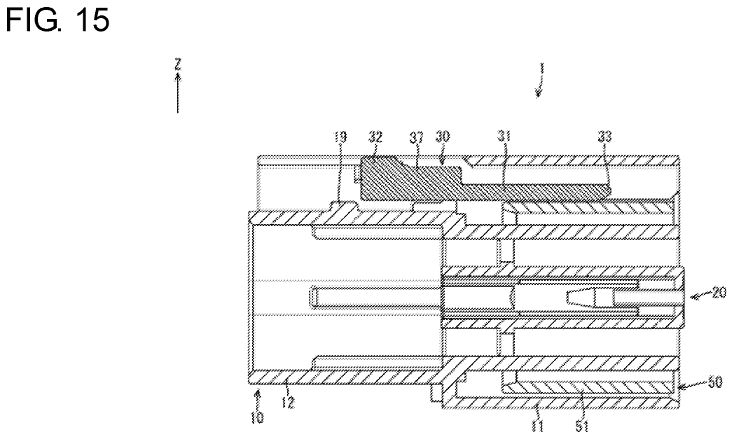

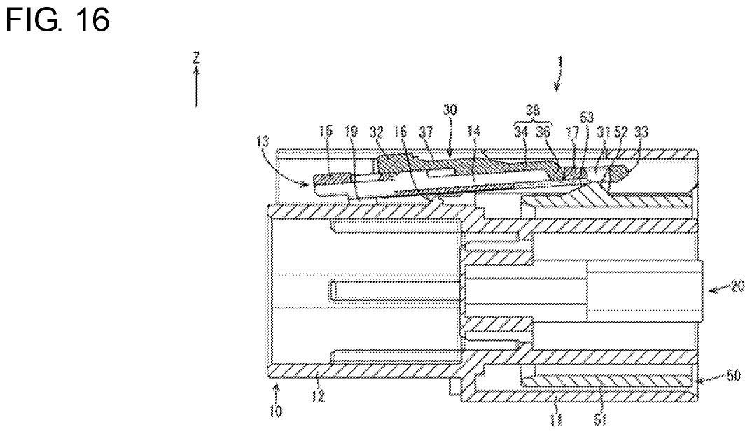

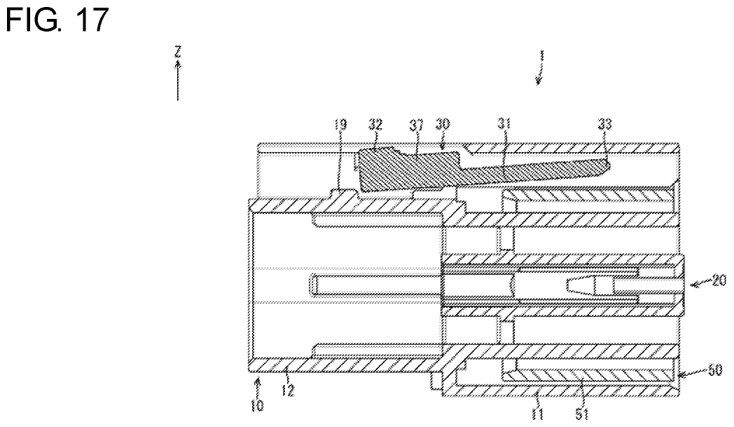

If the CPA latch 30 is moved rearward, the lower surface of the CPA latch body 37 located below the latch pressing portion 32 contacts the projection 19 of the first housing 10, as shown in FIG. 11 to restrict a downward displacement of the latch pressing portion 32. If the latch pressing portion 32 is displaced downward in a state where a rear end part of the CPA latch body 37 located below the latch pressing portion 32 is in front of the projection 19 and behind the base end 16, as shown in FIG. 15, a rear part of the lock arm 13 of the first housing 10 across the base end 16 also is pressed and the latch pressing portion 32 is displaced down together with the first pressing portion 15, as shown in FIGS. 16 and 17. In this way, the latch portion 33 and the first lock 17 are displaced upward.

As shown in FIG. 8, the second housing 50 is a male housing and includes a second opening 51 and a second lock 52. The second opening 51 is open on the connection end to the first housing 10. Although not shown, two second cavities are provided in the second housing 50, and male second terminals are inserted into the respective second cavities. The second lock 52 projects up from the upper surface of the second opening 51. The second lock 52 is tapered in a connecting direction to the first housing 10. By doing so, the first lock 17 and the latch portion 33 first come into contact with a second tapered portion 53 of the second lock 52 when connecting the first and second housings 10, 50. Therefore the first lock 17 and the latch portion 33 easily are displaced upward and an insertion force of the first housing 10 is reduced.

When the first and second housings 10, 50 are connected, the first lock 17 contacts the second lock 52 and is locked to the second lock 52, as shown in FIG. 8. In this state, the first terminals of the first housing 10 and the second terminals of the second housing 50 are connected electrically although not shown.

If the CPA latch 30 is moved forward with the first and second housings 10, 50 connected, the CPA portion 36 moves over a locking portion 70 of the first lock 17, and the second lock 52 and is pushed forwardly of the first lock 17 while the lower surface of the CPA portion 36 and the upper surface of the first lock 17 are sliding on each other, as shown in FIG. 8. On the other hand, although not shown, the CPA portion 36 cannot move over the first lock 17 if the first and second housings 10, 50 are not connected completely (e.g. a state where the upper surface of the second lock 52 and the lower surface of the first lock 17 are in contact). As just described, since the CPA portion 36 moves over the locking portion 70 and is pushed forwardly of the first lock 17 if the first and second housings 10, 50 are connected properly, connection can be assured by the CPA latch 30. If the first pressing portion 15 of the first housing 10 is pushed to displace the first lock 17 upward in this state, the first lock 17 contacts the displacement restricting portion 34 of the CPA latch 30 and an upward displacement of the first lock 17 is restricted.

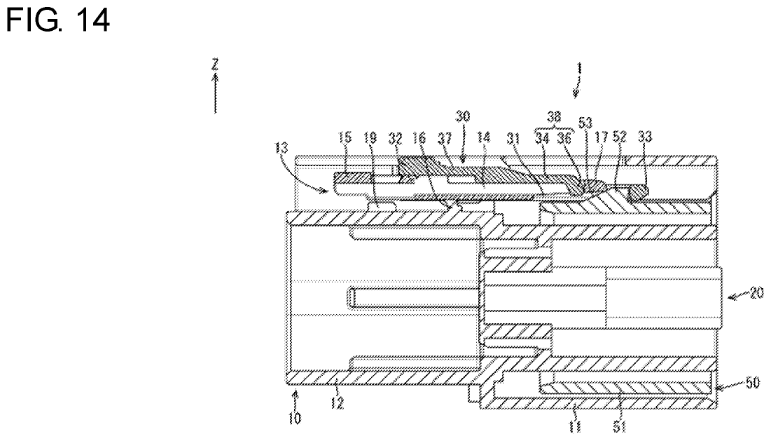

The CPA latch 30 is movable to a connection assurance position (position of the CPA latch 30 shown in FIGS. 8 and 9), a release position (position of the CPA latch 30 shown in FIGS. 10 and 11) and an operation stop position (position of the CPA latch shown in FIGS. 14 and 15). The connection assurance position is the position of the CPA latch 30 in a state where the CPA portion 36 of the CPA latch 30 has moved over the locking portion 70 after the first and second housings 10, 50 are connected, as shown in FIG. 8. The release position is a position that is reached by pulling the CPA latch 30 at the connection assurance position rearward and where the latch portion 33 and the first lock 17 come into contact as shown in FIG. 10. Further, if the first and second housings 10, 50 are separated at the release position, the CPA latch 30 moves forward while the latch portion 33 is caught by the second lock portion 52, as shown in FIGS. 12 to 14. If the CPA latch 30 moves forward, the forward movement restricting portions 35 of the CPA latch 30 and the restricting walls 18 of the first housing 10 come into contact. A forward movement of the CPA latch 30 is stopped with the latch portion 33 and the second lock portion 52 held in contact to prevent separation of the first housing 10 from the second housing 50. The position of the CPA 30 at this time is the operation stop position.

Next, functions of this embodiment are described.

As shown in FIGS. 8 and 9, the first and second housings 10, 50 are connected and the CPA latch 30 is moved from the release position to the connection assurance position. Even if it is attempted to displace the first lock 17 upward by pressing the first pressing portion 15 in this state, the upper surface of the first lock 17 contacts the displacement restricting portion 34 of the CPA latch 30 to impede an upward movement. In this way, the separation of the first housing 10 from the second housing 50 is prevented at the connection assurance position.

The CPA latch 30 initially is pulled rearward to release connection of the first and second housings 10, 50. At this time, the displacement restricting portion 34 is displaced flexibly upward, and the CPA portion 36 rides on the first lock 17 and moves rearward. If the CPA latch 30 is pulled farther rearward, the latch portion 33 of the CPA latch 30 comes into contact with the first lock portion 17, as shown in FIG. 10 and a rearward movement of the CPA latch 30 is stopped. In this way, the CPA latch 30 reaches the release position. At the release position, even if it is attempted to displace the latch portion 33 upward by pressing the latch pressing portion 32, the latch portion 33 cannot be displaced upward since the lower surface of the latch frame 31 is in contact with the projection 19 of the first housing 10 as shown in FIG. 11. In this way, an improper separating operation of separating the first and second housings 10, 50, for example, by simultaneously pressing the first pressing portion 15 and the latch pressing portion 32 is prevented at the release position.

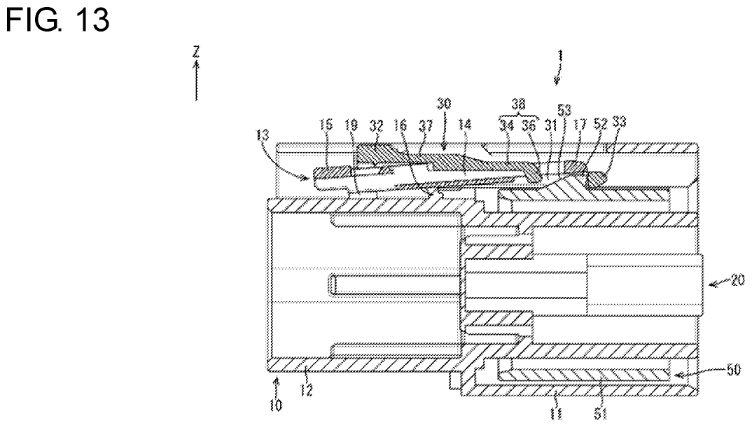

Subsequently, the first lock 17 is unlocked from the second lock 52. First, as shown in FIG. 12, the first pressing portion 15 is pressed to displace the first lock 17 upward. The first housing 10 then is pulled rearward so that the latch portion 33 of the CPA latch 30 and the second lock 52 come into contact, as shown in FIG. 13. At this point of time, an electrically connected state of the first terminals of the first housing 10 and the second terminals of the second housing 50 is released.

If the first housing 10 is pulled farther rearward, the latch portion 33 contacts and is caught by the second portion 52, as shown in FIG. 14, and the CPA latch 30 moves forward. The CPA latch 30 reaches the operation stop position when the forward movement restricting portions 35 of the CPA latch 30 contact the restricting walls 18 of the first housing 10 to impede a rearward movement of the first housing 10. At the operation stop position, the rear end part of the CPA latch body 37 located below the latch pressing portion 32 is in front of the projection 19 and behind the base end 16, as shown in FIGS. 15 and 17. Therefore the latch portion 33 can be displaced upward by pressing the latch pressing portion 32.

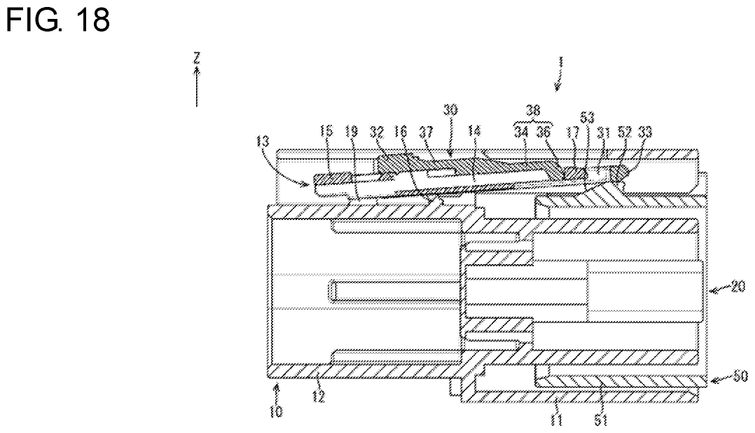

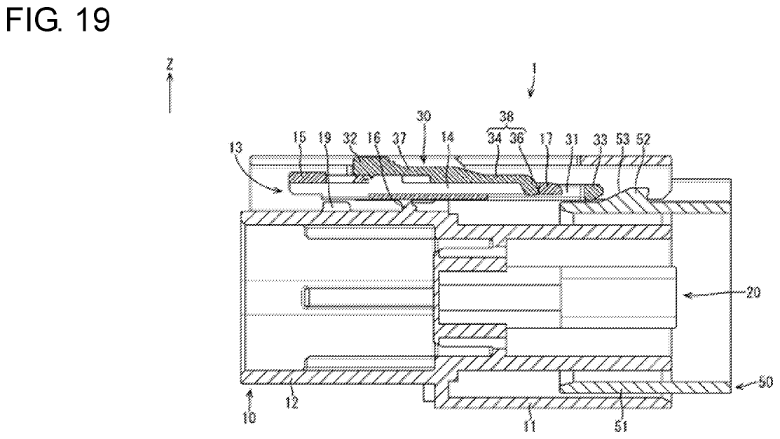

Subsequently, the first and second housings 10, 50 are separated. First, as shown in FIG. 16, the latch pressing portion 32 is pressed. Then, a rear part of the lock arm 13 is pressed downward and the first pressing portion 15 also is displaced downward in conjunction with the first pressing portion 15 since the lower surface of the latch pressing portion 32 and the lock arm 13 of the first housing 10 are in contact. In this way, the latch portion 33 of the CPA latch 30 and the first lock 17 are displaced upward. The first housing 10 can be pulled rearward in this state. Thus, the CPA latch 30 moves rearward while the lower surface of the CPA latch 30 slides on the second lock 52, as shown in FIG. 18. If the first housing 10 is pulled farther rearward, the first and second housings 10, 50 are separated, as shown in FIG. 19, to release the connection of the first and second housings 10, 50. As just described, the latch portion 33 can be displaced upward in a seesaw manner by pressing the latch pressing portion 32. Thus, a connection releasing operation at the operation stop position can be simplified, for example, as compared to the case where the latch portion 33 is lifted directly upward.

In the above way, two functions, i.e. a connection assuring function and a two-action separating function, can be realized by one CPA latch 30 and the number of components can be reduced as compared to the case where the respective functions are realized by different components as before.

As described above, the CPA latch 30 moves over the locking portion 70 of the first lock 17 and the second lock 52 and moves from the release position to the connection assurance position, thereby assuring the connection of the first and second housings 10, 50. Further, if the first and second housings 10, 50 are separated after a movement of the CPA latch 30 to the release position, the CPA latch 30 is locked to the second lock 52 to stop the separating operation and reaches the operation stop position. As just described, the two functions, i.e. the connection assuring function and the two-action separating function can be realized by one CPA latch 30 and the number of components can be reduced as compared to the case where the respective functions are realized by different components as before.

Further, in releasing the connection of the first and second housings 10, 50 by bringing the second lock 52 and the latch portion 33 out of contact at the operation stop position, the latch portion 33 also can be displaced in a seesaw manner to release the connection by pressing and displacing the latch pressing portion 32 of the CPA latch 30. Thus, the connection releasing operation at the operation stop position can be simplified, for example, as compared to the case where the latch portion 33 is lifted and displaced directly upward.

For example, if the latch pressing portion 32 is displaceable at the release position, the first and second housings 10, 50 can be separated by one action without proceeding by way of the operation stop position if the separating operation of the first and second housings 10, 50 is performed with the first pressing portion 15 and the latch pressing portion 32 simultaneously pressed at the release position. However, if a displacement of the latch pressing portion 32 of the CPA latch 30 at the release position is impeded, as in the above configuration, an improper separating operation of separating the first and second housings 10, 50 without proceeding by way of the operation stop position can be prevented.

For example, if the first lock 17 is displaceable at the connection assurance position, the first and second housings 10, 50 can be separated at the connection assurance position. However, if the above configuration is adopted, the displacement restricting portion 34 of the CPA latch 30 suppresses a displacement of the first lock 17. Therefore the separation of the first and second housings 10, 50 at the connection assurance position can be prevented.

The invention is not limited to the above described and illustrated embodiment. For example, the following various modes are also included.

Although the first housing 10 is a female housing and the second housing 50 is a male housing in the above embodiment, the first housing 10 may be a male housing and the second housing 50 may be a female housing.

In the above embodiment, the rear part of the lock arm 13 across the base end portion 16 is also pressed if the latch pressing portion 32 is pressed, and the latch pressing portion 32 is displaced downward together with the first pressing portion 15. However, the latch pressing portion 32 and the first pressing portion 15 may be independently displaced downward.

In the above embodiment, a downward displacement of the latch pressing portion 32 is impeded at the release position by the contact of the CPA latch 30 and the projection 19. However, a downward displacement of the latch pressing portion 32 may be impeded, for example, by providing a projection on a side surface of the latch body portion, providing a groove in an inner wall of the first housing 10 and inserting the projection into the groove provided in the first housing 10 at the release position.

Although the CPA latch 30 is movable in the front-rear direction in the above embodiment, the CPA latch 30 may be movable in another direction, e.g. a direction intersecting the connecting direction, and may reach the connection assurance position if being moved in one direction and reach the release position if being moved in the other direction.

### LIST OF REFERENCE SIGNS

1 . . . connector
10 . . . first housing
17 . . . first lock
19 . . . projection
30 . . . CPA latch
32 . . . latch pressing portion
33 . . . latch portion
34 . . . displacement restricting portion
50 . . . second housing
52 . . . second lock
70 . . . locking portion

1. A connector, comprising:
a first housing including a first lock;
a second housing including a second lock to be locked to the first lock, the second housing being connectable to the first housing; and
a CPA latch relatively movable with respect to the first lock;
wherein:
the CPA latch is movable to:
a release position where a locked state of the first lock and the second lock is releasable;
a connection assurance position where a connected state of the first housing and the second housing is assured by the CPA latch moving over a locking portion of the first lock and the second lock from the release position; and
an operation stop position where a separating operation is stopped by the CPA latch being locked to the second lock while the first housing and the second housing are being separated.

2. The connector of claim 1, wherein:
the CPA latch includes a latch portion and a latch pressing portion;
the separating operation is stopped by the contact of the latch portion and the second lock at the operation stop position; and
the latch portion is displaced in a direction opposite to the latch pressing portion and the latch portion and the second lock are brought out of contact if the latch pressing portion is displaced, thereby making the first housing and the second housing separable.

3. The connector of claim 2, wherein:
the first housing includes a projection;
a displacement of the latch pressing portion is impeded by contact of the CPA latch and the projection at the release position; and
the CPA latch is not in contact with the projection and the latch pressing portion is displaceable at the operation stop position.

4. The connector of claim 3, wherein the CPA latch includes a displacement restricting portion configured to maintain the locked state of the first lock and the second lock by suppressing a displacement of the first lock at the connection assurance position.
